(19) United States
(12) Patent Application Publication
(10) Pub. No.: US 2024/0411869 A1
(43) Pub. Date: Dec. 12, 2024

(54) COLLABORATIVE ALERT PLATFORM USING DISTRIBUTED LEDGER TECHNOLOGY

(71) Applicant: Bank of America Corporation, Charlotte, NC (US)

(72) Inventors: Vinesh Patel, Greenwich (GB); Michael Young, Davidson, NC (US)

(21) Appl. No.: 18/206,801

(22) Filed: Jun. 7, 2023

(51) Int. Cl. G06F 21/55

(52) U.S. Cl. CPC G06F 21/554

(57) ABSTRACT

Aspects of the disclosure relate to a collaborative alert platform using distributed ledger technology. A collaborative alert platform may generate a roster of affiliated entities. The platform may receive one or more alert records corresponding to an impact event from a first entity. The platform may store a first alert record to a distributed ledger. The platform may identify a second entity authorized to view the first alert record. The platform may send the first alert record to the second entity. Sending the first alert record may cause a cybersecurity investigation. The platform may receive a second alert record from the second entity and corresponding to the impact event. The platform may generate an aggregated alert record corresponding to the impact event. The platform may modify the distributed ledger based on generating the aggregated alert record.

### BACKGROUND

In some instances, a system may conduct an investigation (e.g., a cybersecurity investigation, an incident report, an impact alert, and/or other investigations) for a first entity (e.g., an enterprise organization, such as a financial institution, and/or other institutions) based on an impact event (e.g., a cybersecurity risk, a public emergency, an international event, an economic event, and/or other events). In some examples, one or more additional entities (which may, e.g., be associated with a same industry and/or organizational venture as the first entity) may be affected by the same impact event. In some instances, the information related to the investigation may be of import and/or of benefit to the additional entities. However, in some examples, a portion of the information related to the investigation may require authorization to access. Additionally, in some examples, the first entity might not be able to directly communicate with one or more of the additional entities. For example, there may be technical issues that prevent and/or impair collaboration between devices managed by the first entity with devices managed by one or more additional entities. For instance, differences in configurations such as operating systems, compatibility requirements, handshake methods, and/or other factors may prevent the first entity's devices from communicating with devices managed by one or more additional entities. Accordingly, it may be important to provide a secure method by which multiple associated entities, with devices which may have different configurations, may collaborate to share limited portions of information related to an investigation of an impact event with additional affected entities that have the proper authorization.

### SUMMARY

Aspects of the disclosure provide effective, efficient, scalable, and convenient technical solutions that address and overcome the technical problems associated with current methods of sharing information related to investigations of impact events. In accordance with one or more arrangements of the disclosure, a computing platform with at least one processor, a communication interface, and memory storing computer-readable instructions may generate a roster of affiliated entities based on identification information received from a plurality of entities. Each entity may be affiliated with a first organizational venture. The computing platform may receive one or more alert records from a first user device associated with a first entity, of the roster of affiliated entities. A given alert record may include information corresponding to an impact event detected by the first entity, a list of entities affected by the impact event, and a permissions ruleset. The permissions ruleset may include at least one rule for permitting access to the given alert record. The computing platform may store a first alert record, of the one or more alert records. Storing the first alert record may include adding an entry to a stored distributed ledger comprising at least one historical alert record. The computing platform may identify a second entity based on the first alert record. The second entity may be authorized to view the first alert record. The computing platform may send the first alert record to a second user device associated with the second entity based on identifying the second entity. By sending the first alert record, the computing platform may cause the second user device to trigger a cybersecurity investigation. The computing platform may receive a second alert record from the second user device. The second alert record may include information detected by the second entity and corresponding to the impact event detected by the first entity. The computing platform may generate an aggregated alert record corresponding to the impact event detected by the first entity, in the stored distributed ledger. The aggregated alert record may include at least a portion of the first alert record and at least a portion of the second alert record. The computing platform may modify the stored distributed ledger based on the aggregated alert record. Modifying the stored distributed ledger may configure the aggregated alert record for access by devices with access permissions for one or more portions of the aggregated alert record.

In one or more examples, the computing platform may receive a request to access the aggregated alert record corresponding to the impact event detected by the first entity, from a supervisor device. The request may include identifying information corresponding to the supervisor device. The computing platform may compare the identifying information with a plurality of permissions rulesets corresponding to the impact event. Based on identifying that the supervisor device has full access to the aggregated alert record, the computing platform may send, to the supervisor device, the aggregated alert record. Based on identifying that the supervisor device has limited access to the aggregated alert record, the computing platform may generate a modified alert record based on the plurality of permissions rulesets and may send the modified alert record to the supervisor device. The modified alert record may include at least one of: a portion of the first alert record, or a portion of the second alert record.

In one or more instances, the first organizational venture may be and/or include at least one of: a public health venture, a financial venture, a political venture, a charitable venture, or an international venture. In one or more examples, the impact event detected by the first entity may include at least one of the following: an unauthorized transaction, a potentially unlawful action, a potential cyberattack, a security warning, a public health concern, or a public safety concern. In one or more instances, the list of entities affected by the impact event may be determined by an automated process implemented by the first entity.

In one or more examples, the information corresponding to the impact event may include at least one of the following: a source of the impact event, an identity of an entity associated with the impact event, global positioning information associated with the impact event, or temporal information corresponding to the impact event. In one or more instances, sending the first alert record may cause the second user device to initiate one or more security actions, based on a result of the cybersecurity investigation. In one or more examples, sending the first alert record may be further based on receiving a request for the first alert record from the second user device. In one or more instances, the computing platform may send a modified alert record to a third user device associated with a third entity based on the aggregated alert record. The modified alert record may include at least one portion of the second alert record, based on a permissions ruleset of the second alert record. The modified alert record may exclude, based on a permissions ruleset of the first alert record, the first alert record.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for a collaborative alert platform using distributed ledger technology in accordance with one or more example arrangements;

FIGS. 2A-2E depict an illustrative event sequence for a collaborative alert platform using distributed ledger technology in accordance with one or more example arrangements;

FIGS. 3A-3B depict illustrative graphical user interfaces depicting a collaborative alert platform using distributed ledger technology in accordance with one or more example arrangements;

FIG. 4 depicts an illustrative method for a collaborative alert platform using distributed ledger technology in accordance with one or more example arrangements; and

FIG. 5 depicts an illustrative method for providing alert record information to a supervisor device using a collaborative alert platform using distributed ledger technology in accordance with one or more example arrangements.

### DETAILED DESCRIPTION

In the following description of various illustrative arrangements, reference is made to the accompanying drawings, which form a part hereof, and in which is shown, by way of illustration, various arrangements in which aspects of the disclosure may be practiced. In some instances, other arrangements may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief description of the concepts described further herein, some aspects of the disclosure relate to a collaborative alert platform using distributed ledger technology. A first entity (e.g., an enterprise organization, such as a financial institution, and/or other institutions) may detect an impact event (e.g., a cybersecurity risk, a public emergency, an international event, an economic event, and/or other events). In some instances, the first entity may conduct its own investigation (e.g., a cybersecurity investigation, an incident report, an impact alert, and/or other investigations) into the impact event to, e.g., determine how the impact event affects the first entity, prepare a report on the impact event, and/or initiate one or more actions (e.g., cybersecurity actions, public alerts, reports to a supervising entity, and/or other actions). In some instances, the first entity may be involved in and/or associated with a particular organizational venture (e.g., a public health venture, a financial venture, a political venture, a charitable venture, an international venture, and/or other organizational ventures). In these instances, one or more additional entities involved in and/or associated with the same organizational venture may also be affected by the impact event, but might not have detected the impact event prior to the first entity detecting the impact event. Accordingly, it may be beneficial for the first entity to share information and/or the results of its investigation with these one or more additional entities.

However, in some examples, the first entity might not be able to share one or more portions of the information related to the impact event with one or more of the additional entities. For example, the first entity may be an enterprise organization (e.g., a financial institution, and/or other institutions) that may have confidential information involved in the investigation of the impact event. For instance, the impact event may be and/or include a potentially unauthorized transaction which may include confidential transaction information. Additionally or alternatively, in some instances, the first entity may wish to share non-confidential information of the impact event with one entity, of the one or more additional entities, affected by the impact event, but not another entity. For example, the first entity may wish to share the non-confidential information of the impact event with another enterprise organization (e.g., a financial institution, and/or other institutions) affiliated with the first entity (e.g., via a business relationship, and/or other affiliations), but might not wish to share the non-confidential information with an entity unknown to the first entity which may, e.g., be involved in and/or associated with the same organizational venture as the first entity (e.g., a non-affiliated competitor, or the like). Accordingly, it may be important to provide an improved, secure method by which multiple entities involved in and/or associated with the same organizational venture may collaborate to share limited portions of information related to an investigation of an impact event with additional affected entities that have the proper authorization and/or non-affected entities that have the proper authorization.

A collaborative alert platform may be employed by multiple entities associated with the same organizational venture to provide the secure method of sharing information via computing devices as described above (e.g., by sending alert records, which include non-confidential information related to an impact event to share with a subset of affected entities, to the collaborative alert platform for storage in a distributed ledger, and/or by other methods). In some instances, the collaborative alert platform may generate and maintain a roster of affiliated entities, each affiliated with the same organizational venture. In some examples, the collaborative alert platform may receive alert records from entities of the roster of affiliated entities and store the records to a distributed ledger (e.g., by adding and/or by modifying entries to the distributed ledger). In some instances, the collaborative alert platform may identify which entities, of the roster of affiliated entities, to send the alert records to (e.g., by reviewing a permissions ruleset included in each alert record, by receiving requests from one or more entities, and/or other techniques). Additionally, in some examples, the collaborative alert platform may also generate and maintain an aggregated alert record including portions of one or more alert records received by the collaborative alert platform. The collaborative alert platform as described above may therefore provide a secure method for affiliated entities to share limited portions of information related to an investigation of an impact event.

These and various other aspects will be discussed more fully herein.

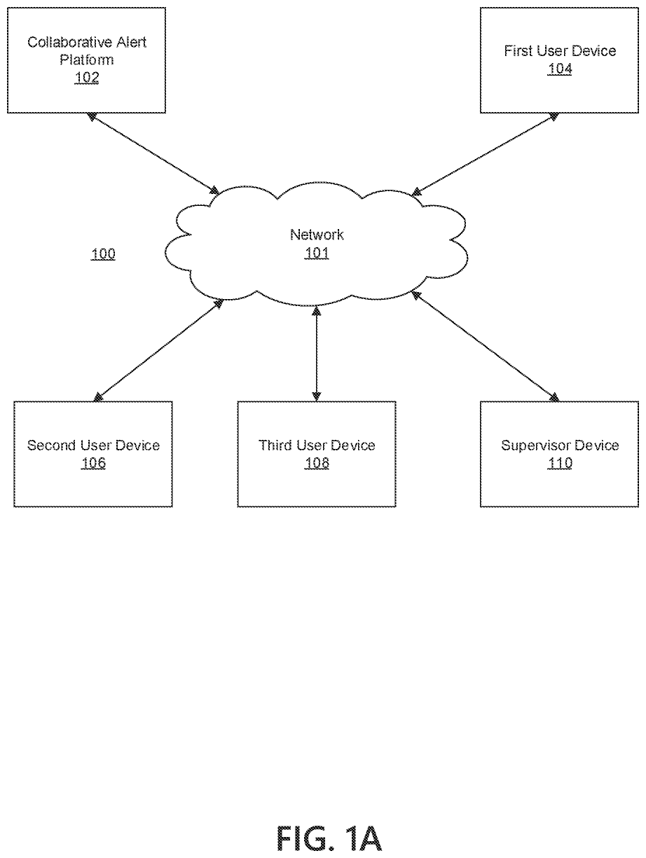

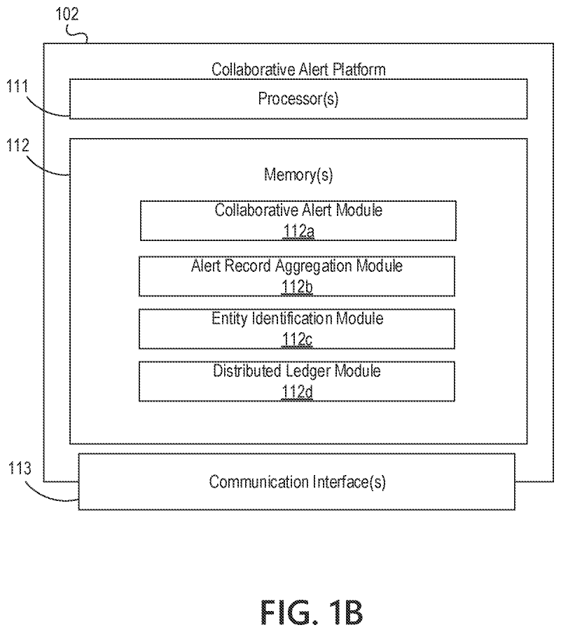

FIGS. 1A-1B depict an illustrative computing environment for a collaborative alert platform using distributed ledger technology in accordance with one or more example arrangements. Referring to FIG. 1A, computing environment 100 may include one or more computer systems. For example, computing environment 100 may include collaborative alert platform 102, a first user device 104, a second user device 106, a third user device 108, and a supervisor device 110.

As described further below, collaborative alert platform 102 may be a computer system that includes one or more computing devices (e.g., servers, laptop computer, desktop computer, mobile device, tablet, smartphone, and/or other devices) and/or other computer components (e.g., processors, memories, communication interfaces) that may be used to host a distributed ledger and maintain a collaborative alert system. For example, the collaborative alert platform 102 may be configured to receive alert records and requests from one or more computing device (e.g., first user device 104, second user device 106, third user device 108, supervisor device 110, and/or other computing device). In some examples, the collaborative alert platform 102 may be further configured to host, maintain, and/or otherwise access a distributed ledger to store and/or validate the alert records. In some instances, the collaborative alert platform 102 may be maintained and/or otherwise accessed by a plurality of organizations (e.g., rather than a single organization). In one or more instances, the collaborative alert platform 102 may be configured to communicate with one or more systems (e.g., first user device 104, second user device 106, third user device 108, supervisor device 110, and/or other systems) to perform an information transfer, display an interface, grant access to the distributed ledger, and/or perform other functions.

The first user device 104 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other user functions (e.g., requesting alert records, sending alert records, displaying user interfaces, and/or other functions). In one or more instances, first user device 104 may correspond to a first entity (e.g., an enterprise organization, such as a financial institution and/or other institution). In one or more examples, the first entity may be involved in and/or associated with an organizational venture (e.g., a public health organizational venture, a financial organizational venture, a political organizational venture, a charitable organizational venture, an international organizational venture, and/or other organizational ventures). In one or more instances, the first user device 104 may be configured to communicate with one or more systems (e.g., collaborative alert platform 102, second user device 106, third user device 108, supervisor device 110, and/or other systems) to perform a data transfer, request alert records, and/or to perform other functions. In some instances, the first user device 104 may be configured to display one or more graphical user interfaces (e.g., cybersecurity display interfaces, and/or other interfaces).

The second user device 106 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other user functions (e.g., requesting alert records, sending alert records, displaying user interfaces, and/or other functions). In one or more instances, second user device 106 may correspond to a second entity (e.g., an enterprise organization, such as a financial institution and/or other institution) different from the first entity. In one or more examples, the second entity may be involved in and/or associated with an organizational venture (e.g., a public health organizational venture, a financial organizational venture, a political organizational venture, a charitable organizational venture, an international organizational venture, and/or other organizational ventures). In some examples, the second entity may be involved in and/or associated with the same organizational venture as the first entity corresponding to first user device 104. In one or more instances, the second user device 106 may be configured to communicate with one or more systems (e.g., collaborative alert platform 102, first user device 104, third user device 108, supervisor device 110, and/or other systems) to perform a data transfer, request alert records, and/or to perform other functions. In some instances, the second user device 106 may be configured to display one or more graphical user interfaces (e.g., cybersecurity display interfaces, and/or other interfaces).

The third user device 108 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other user functions (e.g., requesting alert records, sending alert records, displaying user interfaces, and/or other functions). In one or more instances, third user device 108 may correspond to a third entity (e.g., an enterprise organization, such as a financial institution and/or other institution) different from the first entity and the second entity. In one or more examples, the third entity may be involved in and/or associated with an organizational venture (e.g., a public health organizational venture, a financial organizational venture, a political organizational venture, a charitable organizational venture, an international organizational venture, and/or other organizational ventures). In some examples, the third entity may be involved in and/or associated with the same organizational venture as the second entity corresponding to second user device 106 and/or the first entity corresponding to the first user device 104. In one or more instances, the third user device 108 may be configured to communicate with one or more systems (e.g., collaborative alert platform 102, first user device 104, second user device 106, supervisor device 110, and/or other systems) to perform a data transfer, request alert records, and/or to perform other functions. In some instances, the second user device 106 may be configured to display one or more graphical user interfaces (e.g., cybersecurity display interfaces, and/or other interfaces).

The supervisor device 110 may be a computing device (e.g., laptop computer, desktop computer, mobile device, tablet, smartphone, server, server blade, and/or other device) and/or other data storing or computing component (e.g., processors, memories, communication interfaces, databases) that may be used to transfer information between devices and/or perform other user functions (e.g., requesting alert records, sending alert records, displaying user interfaces, and/or other functions). In one or more instances, supervisor device 110 may correspond to a supervising entity (e.g., a regulatory organization, administrative organization, parent corporation, and/or other supervising entities). In one or more examples, the supervising entity may be associated with an organizational venture (e.g., a public health organizational venture, a financial organizational venture, a political organizational venture, a charitable organizational venture, an international organizational venture, and/or other organizational ventures). In these examples, the supervising entity may be involved in and/or associated with the same organizational venture as the first entity corresponding to first user device 104, the second entity corresponding to second user device 106, and the third entity corresponding to third user device 108. In one or more instances, the supervisor device 110 may be configured to communicate with one or more systems (e.g., collaborative alert platform 102, first user device 104, second user device 106, third user device 108, and/or other systems) to perform a data transfer, request alert records, and/or to perform other functions. In some instances, the second user device 106 may be configured to display one or more graphical user interfaces (e.g., supervising entity display interfaces, and/or other interfaces).

Although only three user devices and one supervisor device is depicted herein, any number of such systems may be used to implement the methods described herein without departing from the scope of the disclosure.

Computing environment 100 also may include one or more networks, which may interconnect collaborative alert platform 102, first user device 104, second user device 106, third user device 108, and supervisor device 110. For example, computing environment 100 may include a network 101 (which may interconnect, e.g., collaborative alert platform 102, first user device 104, second user device 106, third user device 108, and supervisor device 110).

In one or more arrangements, collaborative alert platform 102, first user device 104, second user device 106, third user device 108, and supervisor device 110 may be any type of computing device capable of sending and/or receiving requests and processing the requests accordingly. For example, collaborative alert platform 102, first user device 104, second user device 106, third user device 108, and supervisor device 110, and/or the other systems included in computing environment 100 may, in some instances, be and/or include server computers, desktop computers, laptop computers, tablet computers, or the like that may include one or more processors, memories, communication interfaces, storage devices, and/or other components. As noted above, and as illustrated in greater detail below, any and/or all of collaborative alert platform 102, first user device 104, second user device 106, third user device 108, and supervisor device 110, may, in some instances, be special-purpose computing devices configured to perform specific functions.

Referring to FIG. 1B, collaborative alert platform 102 may include one or more processors 111, memory 112, and communication interface 113. A data bus may interconnect processor 111, memory 112, and communication interface 113. Communication interface 113 may be a network interface configured to support communication between collaborative alert platform 102 and one or more networks (e.g., network 101, or the like). Communication interface 113 may be communicatively coupled to the processor 111. Memory 112 may include one or more program modules having instructions that, when executed by processor 111, cause collaborative alert platform 102 to perform one or more functions described herein and/or one or more databases that may store and/or otherwise maintain information which may be used by such program modules and/or processor 111. In some instances, the one or more program modules and/or databases may be stored by and/or maintained in different memory units of collaborative alert platform 102 and/or by different computing devices that may form and/or otherwise make up collaborative alert platform 102. For example, memory 112 may have, host, store, and/or include a collaborative alert module 112a, alert record aggregation module 112b, entity identification module 112c, distributed ledger module 112d, and/or other modules. Collaborative alert module 112a may have instructions that direct and/or cause collaborative alert platform 102 to receive alert records, send alert records, and/or analyze alert records. Alert record aggregation module 112b may have instructions that direct and/or cause collaborative alert platform 102 to generate an aggregated alert record. Entity identification module 112c may have instructions that direct and/or cause collaborative alert platform 102 to compare permissions lists with authorization information and/or identify entities affected by an impact event. Distributed ledger module 112d may be used to generate, maintain, and/or otherwise access a distributed ledger for alert record storage and/or validation.

Although collaborative alert module 112a, alert record aggregation module 112b, entity identification module 112c, and distributed ledger module 112d are depicted as separate modules herein, the instructions stored by these modules may be stored in any number of modules without departing from the scope of this disclosure.

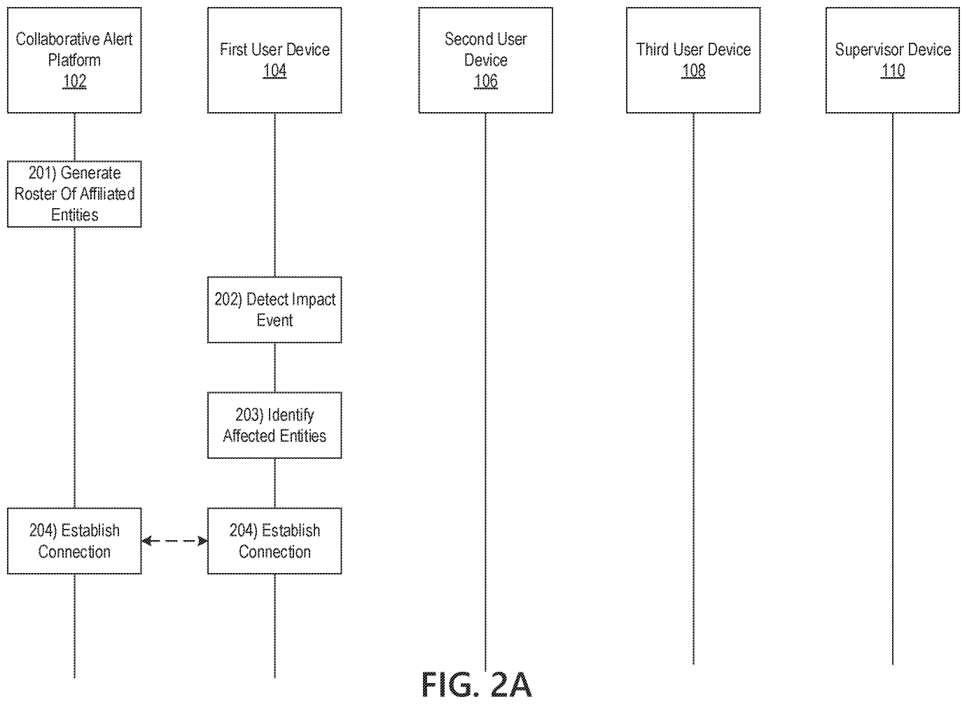

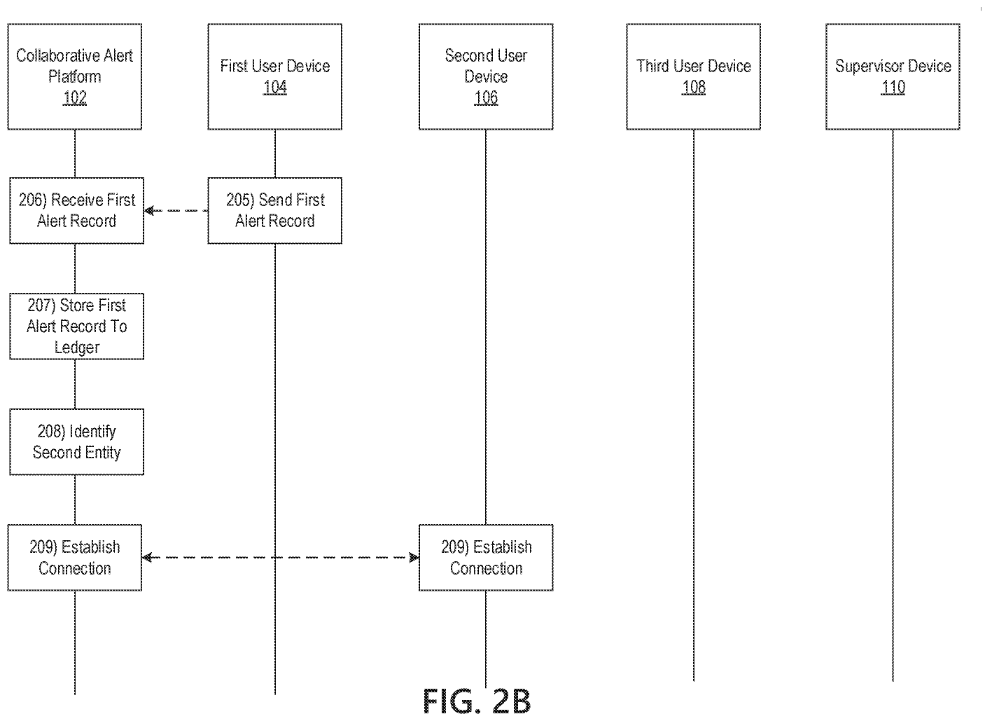

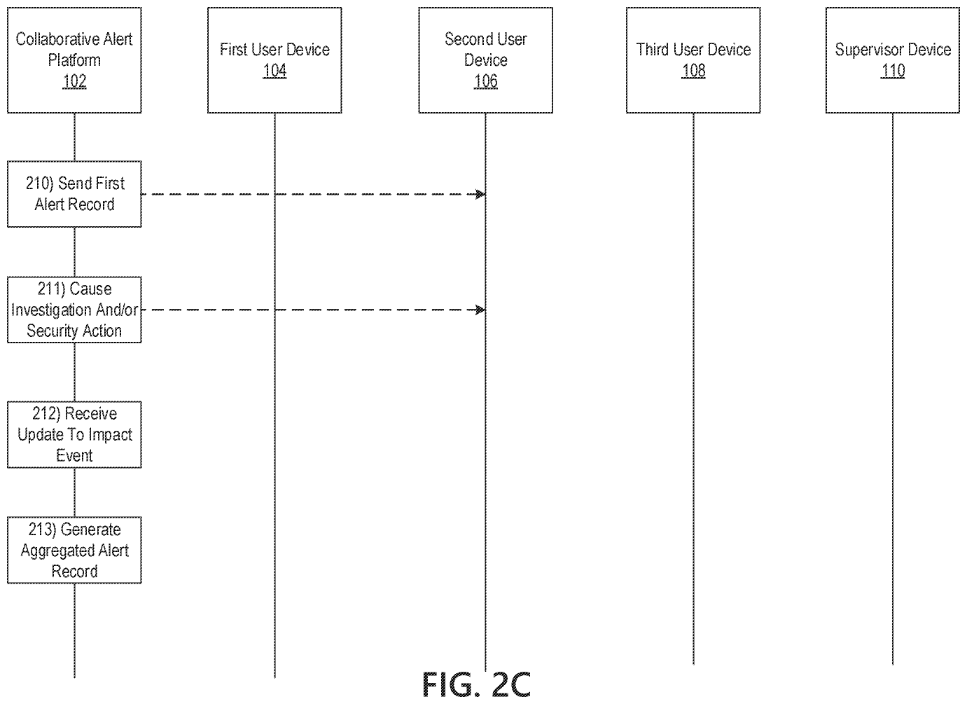

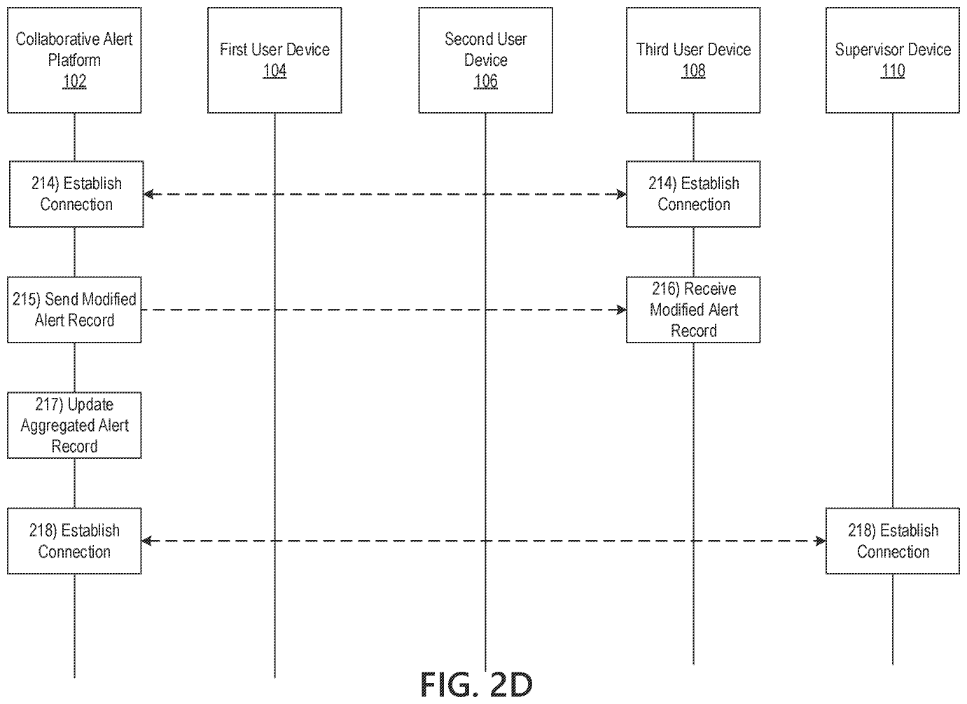

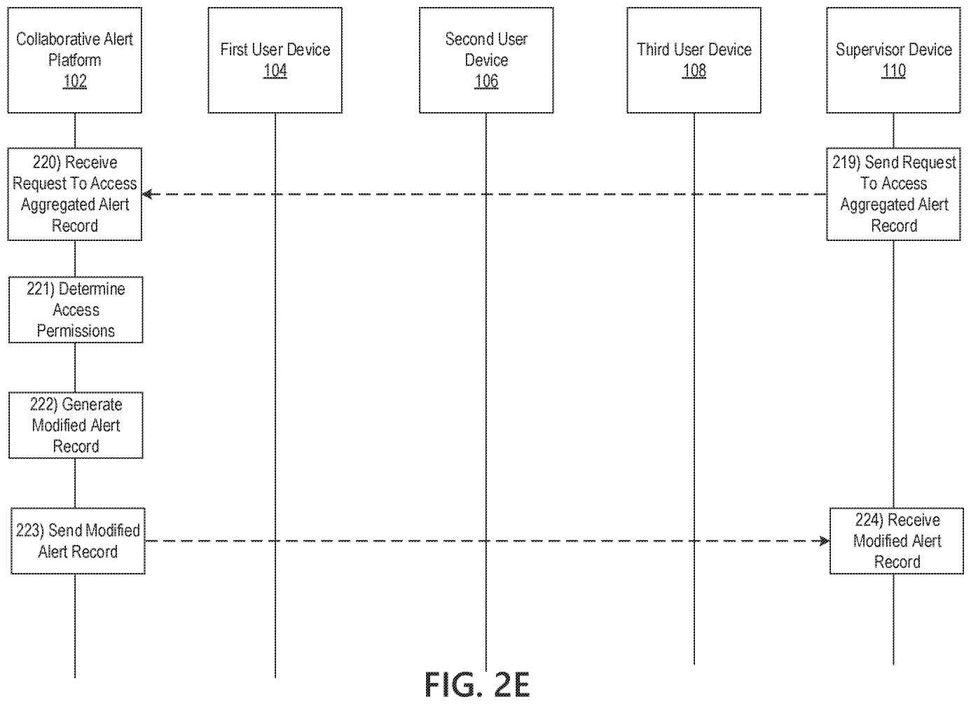

FIGS. 2A-2E depict an illustrative event sequence for a collaborative alert platform using distributed ledger technology in accordance with one or more example arrangements. Referring to FIG. 2A, at step 201, the collaborative alert platform 102 may generate a roster of affiliated entities. For example, the collaborative alert platform 102 may generate a roster of entities (e.g., enterprise organizations, such as financial institutions and/or other institutions) involved in and/or associated with a particular organizational venture (e.g., a public health organizational venture, a financial organizational venture, a political organizational venture, a charitable organizational venture, an international organizational venture, and/or other organizational ventures). In some instances, the collaborative alert platform 102 may have previously received identification information from a plurality of entities involved in and/or associated with the particular organizational venture. For example, the collaborative alert platform 102 may have received identification information from the plurality of entities as part of a registration process offering access to a collaborative alert system implementing collaborative alert platform 102 (e.g., a subscription service, opt-in, signup, and/or other registration processes). In these instances, in generating the roster of affiliated entities, the collaborative alert platform 102 may analyze the previously received identification information for entity names, entity addresses, entity contact information, and/or other identifiers and include said identifiers in the roster of affiliated entities. The roster of affiliated entities may include the first entity corresponding to the first user device 104, the second entity corresponding to the second user device 106, the third entity corresponding to the third user device 108, the supervising entity corresponding to the supervisor device 100, and/or other entities.

In some examples, in generating the roster of affiliated entities, the collaborative alert platform 102 may store the roster of affiliated entities to a distributed ledger, which may, e.g., be hosted and/or otherwise maintained by collaborative alert platform 102 and/or other systems. For example, the collaborative alert platform 102 may add a new entry corresponding to the distributed ledger that includes the roster of affiliated entities, modify an existing entry to include the roster of affiliated entities, and/or otherwise incorporate the roster of affiliated entities into the distributed ledger. Additionally or alternatively, in some instances, the collaborative alert platform 102 may store the roster of affiliated entities to memory (e.g., internal memory 112 of collaborative alert platform 102, and/or external memory). In some examples, the collaborative alert platform 102 may continuously update the roster of affiliated entities to include additional affiliated entities over time (e.g., as new entities register for access to the collaborative alert system implementing collaborative alert platform 102).

At step 202, the first user device 104 may detect an impact event. For example, the first user device 104 may detect at least one of an unauthorized transaction, a potentially unlawful action, a potential cyberattack, a security warning, a public health concern, a public safety concern and/or other impact events that would affect the first entity corresponding to the first user device 104. The first user device 104 may detect the impact event in the course of performing actions that are part of the organizational venture which the first entity is associated with. Additionally or alternatively, in some instances the first user device 104 may detect the impact event based on one or more information sources (e.g., a news source, a report generated by an employee of the entity, a cyberthreat alert system, a public notification system, and/or other information sources). In some examples, the first user device 104 may detect the impact event based on one or more monitoring systems. For example, the first user device 104 may receive periodic (e.g. hourly, weekly, daily, monthly, annual, and/or other periods of time) reports transmitted by the one or more monitoring systems (e.g., weather monitoring systems, public alert systems, cyberthreat intelligence reports, and/or other monitoring systems) which may, e.g., include information indicating an impact event has occurred. For instance, the first user device 104 may receive and/or generate a daily cyberthreat intelligence report flagging all potentially malicious attempts to access a system associated with the first entity (e.g., a database, user device, and/or other systems). The daily cyberthreat intelligence report may, e.g., be generated based on monitoring network traffic and identifying one or more indicators of potential malicious activity.

Additionally or alternatively, in some instances, the first user device 104 may detect the impact event by broadcasting a request for information related to impact events. For example, the first user device 104 may broadcast a request for information related to emergency alert notifications. The request may, e.g., be intercepted by one or more providers of emergency alert information. The one or more providers may, based on intercepting the request, provide the first user device 104 with information related to emergency alert notifications (e.g., weather reports, environmental reports, electrical outage information, and/or other notifications). In these examples, based on the information related to emergency alert notifications, the first user device 104 may detect an impact event which might, e.g., correspond to one or more emergency alert notifications.

In some examples, based on detecting the impact event, the first entity corresponding to the first user device 104 may initiate an investigation into the impact event. For example, the first entity may generate a report, gather information related to the impact event (e.g., the source of the impact event, an identity of an entity associated with the impact event, global positioning information associated with the impact event, temporal information corresponding to the impact event, and/or other information), and/or perform other actions. In these examples, the first entity (e.g., via an employee of the first entity and/or by other means) may store and/or cause storage of the results of the investigation in internal memory of the first user device 104, and/or external memory. For example, an employee and/or other individual associated with the first entity may store the results of the investigation as one or more alert records. In some examples, in storing the results of the investigation as one or more alert records, the first user device 104 (and/or an employee and/or other individual associated with the first entity) may exclude confidential information included in the results of the investigation from the one or more alert records. In some instances, in excluding confidential information, the first user device 104 may use one or more processes (e.g., zero-knowledge proofs, and/or other processes) to include, in the one or more alert records, assertions that the first user device 104 possesses confidential information relating to the impact event without including the confidential information itself.

At step 203, based on detecting the impact event, the first user device 104 may identify a list of entities affected by the impact event. In identifying the list of entities affected by the impact event, the first user device 104 may analyze internal records and/or other information maintained by the first entity to determine, e.g., which entities associated with the first entity may be affected by the impact event detected by first user device 104. For example, the impact event may have been and/or included a potentially unlawful action (e.g., a potentially illegal transaction, and/or other potentially unlawful actions). In this example, the potentially unlawful action may negatively impact one or more entities (which may, e.g., be included in the roster of affiliated entities) known to the first entity. Accordingly, the first user device 104 may identify these one or more entities in the list of entities affected by the impact event. Additionally or alternatively, the list of entities may in be identified using the information gathered and/or detected by the first entity and corresponding to the impact event. For instance, the first user device 104 may identify global positioning system information associated with the impact event indicating that the impact event affects entities located within a specific geographical region (e.g., a region affected by a weather emergency, a region corresponding to a specific news outlet, a region associated with a specific currency, and/or other regions). In identifying the global positioning system information, the first user device 104 may receive and/or access information gathered by a satellite-based radio navigation system, a global positioning computer program, a portable global positioning system, and/or other global positioning systems. Based on the global positioning system information, the first user device 104 may include one or more entities within the geographical region in the list of affected entities.

In some instances, the first user device 104 may include the list of entities affected by the impact event in the alert record or records. In some examples, in identifying the list of entities, the first user device 104 may receive user input from a user (e.g., an analyst associated with the first entity, and/or other users) instructing the first user device 104 to include and/or exclude certain entities from the list of affected entities. For example, an analyst and/or other users may have analyzed the alert record and determined which entities are affected by the impact event (e.g., by using internal information of the first entity, and/or by other means).

Additionally or alternatively, in some examples, in identifying the list of entities, the first user device 104 may receive automated input from an automated process implemented by the first entity. For example, the first entity may implement a pre-configured set of rules, procedures and/or other guidelines (e.g., via a software application, automated computer script, and/or other methods of implementing an automated procedure) for identifying the list of entities. For instance, the first entity may have installed a computer program on first user device 104 configured to automatically identify some or all of the entities engaged in the same organizational venture as the first entity as part of the list of entities affected by the impact event.

In some examples, in identifying the list of entities affected by the impact event, the first user device 104 may also identify and/or generate a permissions ruleset. The permissions ruleset may include at least one rule for permitting access to the alert record or records. For example, the permissions ruleset may include a rule restricting one or more entities, of the list of affected entities, from accessing one or more portions of a given alert record. Additionally or alternatively, the permissions ruleset may include a rule prompting for authorization information from any entities requesting access to a given alert record (e.g., a password, a security code, an identifier, and/or other authorization information). In these examples, the first user device 104 may include the permissions ruleset in the alert record or records.

At step 204, the collaborative alert platform 102 may establish a connection with first user device 104. For example, collaborative alert platform 102 may establish a first wireless data connection with the first user device 104 to link the first user device 104 with the collaborative alert platform 102 (e.g., in preparation for transferring information, and/or other functions). In some instances, the collaborative alert platform 102 may identify whether or not a connection is already established with the first user device 104. If a connection is already established with the first user device 104, the collaborative alert platform 102 might not re-establish the connection. If a connection is not yet established with the first user device 104, the collaborative alert platform 102 may establish the first wireless data connection as described above.

Referring to FIG. 2B, at step 205, the first user device 104 may send the alert record (e.g., a first alert record) described above at steps 202-203 to the collaborative alert platform 102. For example, the first user device 104 may send the alert record via the communication interface 113 and while the first wireless data connection is established. In doing so, the first user device 104 may provide the list of permissions, included in the alert record, to the collaborative alert platform 102. In these instances, the first entity may be confident that their information is secure (e.g., as access to the alert record may be prevented to any entities excluded by the list of permissions). Additionally, as described above at step 202, the first entity may have previously excluded confidential information from the alert record, ensuring the confidential information remains secure.

At step 206, the collaborative alert platform 102 may receive the alert record from first user device 104. For example, the collaborative alert platform 102 may receive the alert record via the communication interface 113 and while the first wireless data connection is established. The alert record received by collaborative alert platform 102 and sent by first user device 104 may include the list of entities affected by the impact event, the permissions ruleset, and information corresponding to the impact event (e.g., at least one of: a source of the impact event, an identity of an entity associated with the impact event, global positioning information associated with the impact event, temporal information corresponding to the impact event, and/or other information corresponding to the impact event). The information corresponding to the impact event may, e.g., have been gathered by the first entity corresponding to first user device 104 in the course of the investigation described above at step 202.

At step 207, based on receiving the alert record from first user device 104, the collaborative alert platform 102 may store the alert record to the distributed ledger. For example, the collaborative alert platform 102 may modify the distributed ledger by adding a new entry corresponding to the alert record, modifying an existing entry to include the alert record, and/or otherwise incorporating the alert record into the distributed ledger. In some instances, the distributed ledger may include one or more historical alert records. For example, the collaborative alert platform 102 may have previously received the one or more historical alert records from one or more entities included in the roster of affiliated entities and stored them to the distributed ledger. In these instances, the collaborative alert platform 102 may store the alert record by modifying an entry of the distributed ledger including at least one historical alert record to include the alert record received from first user device 104 as well.

At step 208, the collaborative alert platform 102 may identify a second entity. For example, the collaborative alert platform 102 may identify the second entity corresponding to the second user device 106. In identifying the second entity, the collaborative alert platform 102 may search, mine, parse, and/or otherwise analyze the alert record. For example, the collaborative alert platform 102 may analyze the list of entities affected by the impact event, included in the alert record. The list of entities affected by the impact event may include the second entity, and the collaborative alert platform 102 may identify the second entity by analyzing the list. In some instances, in identifying the second entity, the collaborative alert platform 102 may additionally analyze the permissions ruleset included in the alert record. For example, the collaborative alert platform 102 may analyze the permissions ruleset concurrently with the list of entities affected by the impact event (e.g., by comparing the list of entities with the permissions ruleset, and/or by other methods) to identify an entity included in the list of affiliated entities which may, e.g., also be authorized to access and/or view the alert record.

Additionally or alternatively, in some instances, the collaborative alert platform 102 may receive a request to access the alert record (e.g., from the second user device 106, and/or from other computing devices, via the communication interface 113). In these instances, the collaborative alert platform 102 may identify the second entity based on receiving the request to access the alert record. For example, the collaborative alert platform 102 may compare identifying information of the entity sending the request to access the alert record with the list of affected entities and/or the permissions ruleset included in the alert record. Based on the comparison, the collaborative alert platform 102 may identify the second entity based on determining that the entity associated with the request to access the alert record is included in the list of affected entities and/or is authorized to view the alert record by the permissions ruleset.

At step 209, the collaborative alert platform 102 may establish a connection with second user device 106 based on identifying the second entity, corresponding to second user device 106, as described above at step 208. For example, collaborative alert platform 102 may establish a second wireless data connection with the second user device 106 to link the second user device 106 with the collaborative alert platform 102 (e.g., in preparation for transferring information, and/or other functions). In some instances, the collaborative alert platform 102 may identify whether or not a connection is already established with the second user device 106. If a connection is already established with the second user device 106, the collaborative alert platform 102 might not re-establish the connection. If a connection is not yet established with the second user device 106, the collaborative alert platform 102 may establish the second wireless data connection as described above.

Referring to FIG. 2C, at step 210, the collaborative alert platform 102 may send the alert record to the second user device 106. For example, the collaborative alert platform 102 may send the alert record based on identifying the second entity, corresponding to second user device 106, as described above at step 208. In doing so, the collaborative alert platform 102 may send the alert record via the communication interface 113 and while the second wireless data connection is established. In some instances, the collaborative alert platform 102 may only send a portion of the alert record. For example, based on one or more rules included in the permissions ruleset, the collaborative alert platform 102 may exclude one or more portions of the alert record which may, e.g., include information the second entity corresponding to second user device 106 does not have authorization to view. For instance, the collaborative alert platform 102 may send the list of entities affected by the impact event and a portion of the information corresponding to the impact event detected by the first entity.

In some examples, in sending the alert record to the second user device 106, the collaborative alert platform 102 may send the alert record automatically, based on identifying the second entity, corresponding to the second user device 106, as described above at step 208. Additionally or alternatively, in some instances, in sending the alert record to the second user device 106, the collaborative alert platform 102 may send the alert record based on and/or in response to receiving a request for the alert record from the second user device 106 (e.g., via the communication interface 113 and while the second wireless data connection is established). In some instances, in sending the alert record to the second user device 106, the collaborative alert platform 102 may cause the second user device 106 to initiate an investigation into the impact event (e.g., as described below at step 211).

At step 211, based on sending the alert record to the second user device 106, the collaborative alert platform 102 may cause the second user device 106 to initiate an investigation (e.g., a cybersecurity investigation, such as a threat scan, a diagnostic report, an internal review, display of a warning notification, and/or other investigations). For instance, as part of the registration process offering access to a collaborative alert system implementing collaborative alert platform 102, collaborative alert platform 102 may be configured to provide display notifications (e.g., cybersecurity alert displays, and/or other display notifications) to user devices (e.g., second user device 106, and/or other user devices) registered to access the collaborative alert system. In these instances, in sending the alert record to the second user device 106, the collaborative alert platform 102 may additionally send one or more commands directing the second user device 106 to display a user interface (e.g., a cybersecurity alert display interface, and/or other interfaces). In some instances, in causing the second user device 106 to initiate a cybersecurity investigation, the collaborative alert platform 102 may send one or more commands directing the second user device 106 to initiate the cybersecurity investigation (e.g., via the communication interface 113 and while the second wireless data connection is established, and/or via other methods).

Based on receiving the alert record from collaborative alert platform 102 and/or based on the collaborative alert platform 102 causing the second user device 106 to initiate the investigation, the second user device 106 may initiate an investigation into the impact event (e.g., a cybersecurity investigation, and/or other investigations). For example, the second user device 106 may alert one or more individuals associated with the second entity of the impact event who may, e.g., perform an investigation into the impact event. In initiating the investigation, the second user device 106 may initiate an investigation similar to the investigation described above at step 202. For example, the second user device 106 may cause the second entity to generate a report, gather information related to the impact event (e.g., the source of the impact event, an identity of an entity associated with the impact event, global positioning information associated with the impact event, temporal information corresponding to the impact event, and/or other information), and/or perform other actions.

Additionally or alternatively, in some instances, the collaborative alert platform 102 may cause the second user device 106 to initiate an investigation into the impact event using internal processes of the second user device 106. The internal processes may include initiating a malware scan, reviewing one or more transaction histories, adding one or more identifiers for potentially malicious entities to an internal threat database, and/or other internal processes. For example, the collaborative alert platform 102 may send one or more commands directing the second user device 106 to initiate a malware scan, which may cause the second user device 106 to scan the second user device 106 for one or more indicators of malware (e.g., a spike in central processing unit usage, repeated copies of files, unusual network activity, reduced hard drive space, a number of browser redirects, and/or other indicators).

In some examples, the second entity (e.g., via an employee of the second entity and/or by other means) may store and/or cause storage of the results of the investigation in internal memory of the second user device 106, and/or external memory. For example, an employee and/or other individual associated with the second entity may store the results of the investigation as one or more alert records (e.g., a second alert record). In some examples, in storing the results of the investigation as one or more alert records, the second user device 106 (and/or an employee and/or other individual associated with the second entity) may exclude confidential information included in the results of the investigation from the one or more alert records.

Additionally or alternatively, in some instances, based on the alert record the collaborative alert platform 102 may cause the second user device 106 to initiate one or more security actions. For example, the collaborative alert platform 102 may send one or more commands to the second user device 106 directing the second user device 106 to initiate one or more security actions responsive to the impact event which may, e.g., cause the second user device 106 to initiate the one or more security actions. For instance, in some examples the second user device 106 may perform one or more actions designed to prevent and/or mitigate damage from a cybersecurity attack. For example, the second user device 106 may disable one or more applications designated as being at risk of a cybersecurity attack (e.g., based on the information included in the alert record), quarantine one or more devices in a network managed by the second entity (e.g., via a microsegmentation process, and/or by via other processes), disable access to one or more assets associated with the second entity (e.g., user accounts, transaction information, client contact information, and/or other assets), and/or perform other actions designed to prevent and/or mitigate damage from a cybersecurity attack.

In some examples, the one or more commands from the collaborative alert platform 102 may cause the second user device 106 to initiate the one or more security actions based on the results of an investigation (e.g., an investigation caused by the collaborative alert platform 102, as described above). For example, the impact event may have been a potential cyberattack detected by the first entity. Based on the investigation initiated by second user device 106 resulting in, e.g., a determination that the potential cyberattack is a threat to the second entity, the second user device 106 may initiate one or more security actions responsive to the potential cyberattack. For example, the second user device 106 may send a security alert, modify authentication information (e.g., passwords, authentication codes, digital keys, and/or other authentication information), perform a malware scan, and/or initiate other actions designed to prevent a cyberattack.

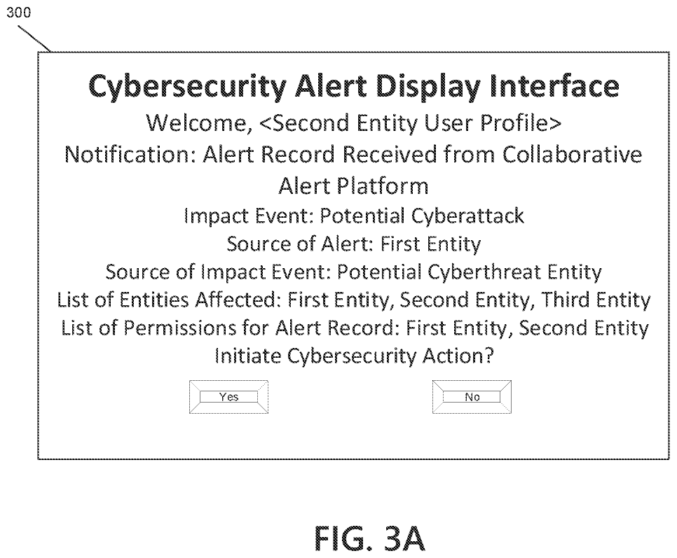

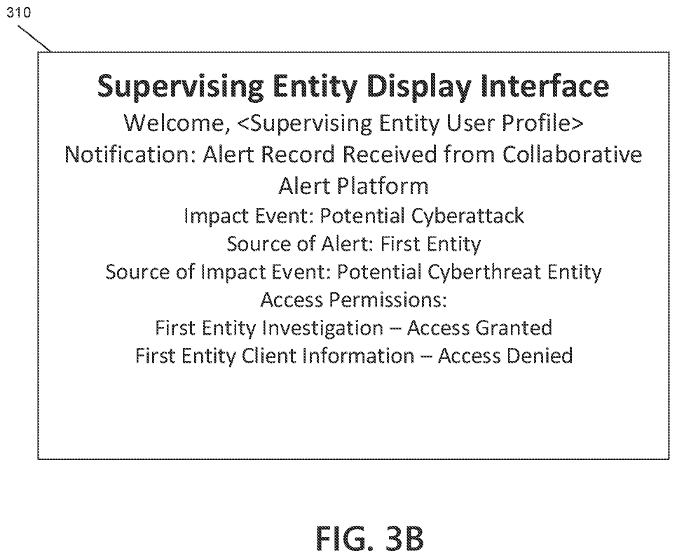

Additionally or alternatively, in some examples, based on receiving one or more commands directing the second user device 106 to display a user interface at step 210, the second user device 106 may cause display of a user interface representing the alert record sent by collaborative alert platform 102. For example, the third user device 108 may display a graphical user interface similar to cybersecurity alert display interface 300, as illustrated in FIG. 3A.

Referring to FIG. 3A, in some instances, the cybersecurity alert display interface 300 may include information corresponding to the alert record. For example, the cybersecurity alert display interface 300 may include information such as a notification that the alert record was received from the collaborative alert platform 102, information corresponding to the impact event (e.g., the type of impact event, the source of the alert record, the source of the impact event, and/or other information corresponding to the impact event), the list of entities affected by the impact event, the list of permissions for the alert record, and/or other information. The cybersecurity alert display interface 300 may also display interface elements or selectable options requesting user input. For example, the cybersecurity alert display interface 300 may display one or more of: a button or buttons, toggle or toggles, check box or boxes, and/or other interface elements. For example, as illustrated in FIG. 3A, the interface elements may be buttons the user can select to decide whether or not to initiate a security action. Based on user input directing the user device (e.g., second user device 106, and/or other user devices) to initiate the security action, the user device (e.g., second user device 106, and/or other user devices) may initiate at least one security action, as described above at step 211.

Referring back to FIG. 2C, at step 212, the collaborative alert platform 102 may receive an update to the impact event detected by the first entity. In some instances, in receiving the update to the impact event, the collaborative alert platform 102 may receive a second alert record which may, e.g., have been generated by the second user device 106, as described above at step 211. The second alert record may include information corresponding to the impact event detected by the first entity. For example, the second alert record may include information gathered and/or detected by the second entity and related to the impact event (e.g., the source of the impact event, an identity of an entity associated with the impact event, global positioning information associated with the impact event, temporal information corresponding to the impact event, and/or other information).

Additionally, in some examples, the second alert record may further include a list of entities affected by the impact event (e.g., the list of entities included in the alert record sent to second user device 106 by collaborative alert platform 102, a list of entities generated by the second user device 106, and/or other lists of entities affected by the impact event) and/or a permissions ruleset. For example, in some instances, the second alert record may include a list of entities generated by the second user device using the information gathered and/or detected by the second entity. For instance, the second user device 106 may identify global positioning system information associated with the impact event indicating that the impact event affects entities located within a specific geographical region (e.g., a region affected by a weather emergency, a region corresponding to a specific news outlet, a region associated with a specific currency, and/or other regions). Based on the global positioning system information, the second user device 106 may include one or more entities within the geographical region in the list of affected entities The permissions ruleset may be and/or include at least one rule of the permissions ruleset included in the alert record sent from collaborative alert platform 102 to second user device 106 (e.g., as described above at step 210), a permissions ruleset generated by the second user device 106, and/or other permissions ruleset.

Additionally or alternatively, the collaborative alert platform 102 may receive the update to the impact event from one or more sources different from second user device 106. For instance, in some examples, the collaborative alert platform 102 may receive an updated alert record from first user device 104 which may, e.g., include additional information corresponding to the impact event detected by the first entity. Additionally or alternatively, in some instances, the collaborative alert platform 102 may receive an alert record (which may, e.g., include similar information corresponding to the first impact event, a list of entities affected by the impact event, a permissions ruleset, and/or other information) from one or more additional user devices associated with entities included in the roster of affiliated entities (e.g., third user device 108, and/or other user devices).

At step 213, the collaborative alert platform 102 may generate an aggregated alert record based on receiving the update to the impact event. For example, the collaborative alert platform 102 may generate the aggregated alert record based on receiving the second alert record from the second user device 106. In generating the aggregated alert record, the collaborative alert platform 102 may generate an aggregated alert record that includes at least a portion of the first alert record received from the first user device 104 (e.g., as described above at step 206), at least a portion of the second alert record received from the second user device 106 (e.g., as described above at step 212), and/or other portions of additional alert records different from the first alert record and the second alert record). In these instances, the collaborative alert platform 102 may store the aggregated alert record to the distributed ledger. For example, the collaborative alert platform 102 may modify the distributed ledger by adding a new entry corresponding to the aggregated alert record, modifying an existing entry to include the aggregated alert record, and/or otherwise incorporating the aggregated alert record into the distributed ledger. Additionally or alternatively, in some instances, in generating the aggregated alert record, the collaborative alert platform 102 may generate one or more indications, where the indications indicate which entry or entries of the distributed ledger incorporate the at least a portion of the first alert record and the at least a portion of the second alert record. In these examples, the collaborative alert platform 102 may store the indications to the distributed ledger, in the method described above.

In some instances, in storing the aggregated alert record by adding a new entry to the distributed ledger and/or modifying the distributed ledger, the collaborative alert platform 102 may configure the aggregated alert record for access by devices with access permissions for one or more portions of the aggregated alert record. For example, the collaborative alert platform 102 may modify the entry or entries of the distributed ledger to grant access to user devices based on the permissions rulesets corresponding to each portion of the aggregated alert record. In doing so, the collaborative alert platform 102 may, e.g., configure each portion of the aggregated alert record for access only by those user devices which would have had access to the corresponding alert record included in each portion of the aggregated alert record. For instance, the aggregated alert record may be configured such that a portion corresponding to the first alert record may only be accessed by first user device 104 and/or second user device 106 based on the permissions ruleset included in the first alert record. In these instances, based on, e.g., a future request from second user device 106 to access the portion of the aggregated alert record, the collaborative alert platform 102 may provide the requested portion of the aggregated alert record (which may, e.g., cause the second user device to initiate a cybersecurity investigation, as described above at step 211.)

Referring to FIG. 2D, at step 214, in some instances, the collaborative alert platform 102 may establish a connection with third user device 108. The collaborative alert platform 102 may establish the connection with third user device 108 based on a triggering event (e.g., a request to access the aggregated alert record previously received from third user device 108, an identification by collaborative alert platform 102 that one or more portions of the aggregated alert record should be sent to third user device 108 based on a list of entities affected by the impact event, a request from second user device 106 to send one or more portions of the aggregated alert record to third user device 108, and/or other triggering events). For example, collaborative alert platform 102 may establish a third wireless data connection with the third user device 108 to link the third user device 108 with the collaborative alert platform 102 (e.g., in preparation for transferring information, and/or other functions). In some instances, the collaborative alert platform 102 may identify whether or not a connection is already established with the third user device 108. If a connection is already established with the third user device 108 (e.g., a connection initiated by the third user device 108 to send a request to access the aggregated alert record, and/or other connections), the collaborative alert platform 102 might not re-establish the connection. If a connection is not yet established with the third user device 108, the collaborative alert platform 102 may establish the third wireless data connection as described above.

At step 215, the collaborative alert platform 102 may send a modified alert record to the third user device 108. The modified alert record may include one or more portions of the aggregated alert record (e.g., a portion of the first alert record received from the first user device 104 (e.g., as described above at step 206), a portion of the second alert record received from the second user device 106 (e.g., as described above at step 212), and/or other portions of the aggregated alert record). In some instances, the modified alert record may be based on one or more permissions rulesets included in alert records which make up the aggregated alert record. For example, the modified alert record may include at least one portion of a given alert record (e.g., the second alert record, and/or other alert records) based on the permissions ruleset of the given alert record including a rule authorizing the third user device 108 to view the given alert record. Additionally or alternatively, the modified alert record may exclude at least one portion of a given alert record (e.g., the first alert record, and/or other alert records) based on the permissions ruleset of the given alert record including a rule indicating that the third user device 108 is not authorized to view the given alert record. In sending the modified alert record, the collaborative alert platform 102 may send the modified alert record via the communication interface 113 and while the third wireless data connection is established.

At step 216, the third user device 108 may receive the modified alert record from collaborative alert platform 102 and sent at step 215. For example, the third user device 108 may receive the modified alert record via the communication interface 113 and while the third wireless data connection is established.

At step 217, in some instances, the collaborative alert platform 102 may update the aggregated alert record. For example, the collaborative alert platform 102 may update the aggregated alert record based on the collaborative alert platform 102 receiving an updated alert record from a user device which previously sent an alert record (e.g., first user device 104, second user device 106, and/or other use devices) which may, e.g., include additional information corresponding to the impact event detected by the first entity. Additionally or alternatively, in some instances, the collaborative alert platform 102 may receive a new alert record (which may, e.g., include similar information corresponding to the first impact event, a list of entities affected by the impact event, a permissions ruleset, and/or other information) from one or more additional user devices associated with entities included in the roster of affiliated entities (e.g., third user device 108, and/or other user devices). In updating the aggregated alert record, the collaborative alert platform 102 may modify the distributed ledger by adding a new entry to the distributed ledger including updated information corresponding to the impact event, modifying an existing entry of the distributed ledger to include the updated information corresponding to the impact event, and/or otherwise incorporating updated information corresponding to the impact event into the distributed ledger.

At step 218, in some instances, collaborative alert platform 102 may establish a connection with supervisor device 110. The collaborative alert platform 102 may establish the connection with supervisor device 110 based on a triggering event (e.g., receiving an alert record from a user device such as first user device 104, second user device 106, third user device 108, and/or other user devices, a request to establish a connection from supervisor device 110, and/or other triggering events). For example, in some instances the supervisor device 110 may request a connection with collaborative alert platform 102 to access a report (which may, e.g., be included in an alert record) on the impact event from an entity (e.g., the first entity, the second entity, the third entity, and/or other entities included in the roster of affiliated entities). In other examples, the collaborative alert platform 102 may automatically establish the connection with supervisor device 110 based on supervisory guidelines established by the supervising entity corresponding to supervisor device 110. In these examples, the collaborative alert platform 102 may automatically determine access permissions e.g., as described at step 221 below, and may not perform the actions described in steps 219-220 below.

In establishing the connection with supervisor device 110, collaborative alert platform 102 may establish a fourth wireless data connection with the supervisor device 110 to link the supervisor device 110 with the collaborative alert platform 102 (e.g., in preparation for transferring information, and/or other functions). In some instances, the collaborative alert platform 102 may identify whether or not a connection is already established with the supervisor device 110. If a connection is already established with the supervisor device 110, the collaborative alert platform 102 might not re-establish the connection. If a connection is not yet established with the supervisor device 110, the collaborative alert platform 102 may establish the fourth wireless data connection as described above.

Referring to FIG. 2E, at step 219, the supervisor device 110 may send a request to access the aggregated alert record to collaborative alert platform 102. For example, the supervisor device 110 may send the request via the communication interface 113 and while the fourth wireless data connection is established. In some examples, the request to access the aggregated alert record may request information related to the impact event and required (e.g., by law, procedure, corporate guidelines, and/or other rules) to be reported to the supervising entity corresponding to the supervisor device 110. Additionally or alternatively, in some instances, the request may include identifying information of the supervising entity corresponding to the supervisor device 110 (e.g., credentials, signatures, certifications, and/or other identifying information)

At step 220, the collaborative alert platform 102 may receive the request from supervisor device 110 and sent at step 219. For example, the collaborative alert platform 102 may receive the request via the communication interface 113 and while the fourth wireless data connection is established.

At step 221, the collaborative alert platform 102 may determine access permissions based on the request received from supervisor device 110. For example, the collaborative alert platform 102 may determine whether the request includes a request to access information outside the scope of information required by the supervising agency. In determining access permissions, the collaborative alert platform 102 may analyze the request to identify requested information (e.g., one or more portions of one or more alert records included in the aggregated alert record, and/or other requested information). Based on identifying the requested information, the collaborative alert platform 102 may access, in the distributed ledger, a plurality of permissions rulesets including the permissions rulesets associated with each portion of the requested information. In some examples, the collaborative alert platform 102 may compare identifying information of the supervising entity included in the request with the plurality of permissions rulesets in order to determine which portions of the aggregated alert record the supervising entity has authorization to access.

In some instances, the collaborative alert platform 102 may determine that the supervisor device 110 has full access to the aggregated alert record (e.g., based on one or more rules in the plurality of permissions rulesets granting supervising entities full access to alert records). In these instances, based on identifying that the supervisor device 110 has full access to the aggregated alert record, the collaborative alert platform 102 may send the aggregated alert record to the supervisor device 110 (e.g., via the communication interface 113 and while the fourth wireless data connection is established) and may, e.g., not perform the actions described at steps 222-224 below. Additionally or alternatively, in some examples, the collaborative alert platform 102 may determine that the supervisor device 110 has limited access to the aggregated alert record. For example, in some instances, the plurality of permissions rulesets may include one or more rules granting supervising entities full access to alert records generated by the entities subject to supervision by the supervising entities. However, in such instances, the roster of affiliated entities may include one or more entities subject to different supervising entities. Accordingly, the collaborative alert platform 102 may determine that the supervisor device 110 only has access permissions for the portions of the aggregated alert record generated by the entities subject to supervision by the entity associated with supervisor device 110. In these examples, the collaborative alert platform 102 may proceed to step 222 as described below.

At step 222, based on identifying that the supervisor device 110 has limited access to the aggregated alert record, the collaborative alert platform 102 may generate a modified alert record to provide to the supervisor device 110. For example, the collaborative alert platform 102 may generate a modified alert record that includes one or more portions of the aggregated alert record which the collaborative alert platform 102 previously determined the supervisor device 110 has permission to access (e.g., as described above at step 221). For instance, the collaborative alert platform 102 may, based on determining that the supervisor device 110 has permission to access the alert record sent by first user device 104 at step 206 and the second alert record that may, e.g., have been sent by second user device 106 at step 212, the collaborative alert platform 102 may generate a modified alert record including at least one portion of the alert record sent by first user device 104 and/or at least one portion of the second alert record, sent by second user device 106. Additionally or alternatively, in some examples, the modified alert record may include one or more additional portions of one or more additional alert records included in the aggregated alert record.

At step 223, the collaborative alert platform 102 may send the modified alert record to supervisor device 110. For example, the collaborative alert platform 102 may send the modified alert record via the communication interface 113 and while the fourth wireless data connection is established. In some instances, in sending the modified alert record, the collaborative alert platform 102 may additionally send one or more commands directing the supervisor device 110 to display a user interface (e.g., a supervising entity display interface, and/or other user interfaces).

At step 224, the supervisor device 110 may receive the modified alert record from collaborative alert platform 102. For example, the supervisor device 110 may receive the modified alert record via the communication interface 113 and while the fourth wireless data connection is established. In some examples, the supervisor device 110 may additionally receive the one or more commands directing the supervisor device 110 to display a user interface (e.g., a supervising entity display interface, and/or other user interfaces). In these examples, based on receiving the one or more commands directing the supervisor device 110 to display a user interface, the supervisor device 110 may cause display of a user interface representing the modified alert record. For example, the supervisor device 110 may display a graphical user interface similar to supervising entity display interface 310, as illustrated in FIG. 3B.

Referring to FIG. 3B, in some instances, the supervising entity display interface 310 may include information corresponding to the modified alert record. For example, the supervising entity display interface 310 may include information such as a notification that the modified alert record was received from the collaborative alert platform 102, information corresponding to the impact event and requested by the supervisor device 110 (e.g., the type of impact event, the source of the alert record, the source of the impact event, and/or other information corresponding to the impact event), the list of entities affected by the impact event, the list of permissions for the alert record, and/or other information. The supervising entity display interface 310 may also display information related to the supervising entity's access permissions (e.g., an indication that the modified alert record includes all of the information required to be reported to the supervising entity, an indication of the information included in the aggregated alert record that is not subject to supervision by the supervising entity, and/or other access permissions).

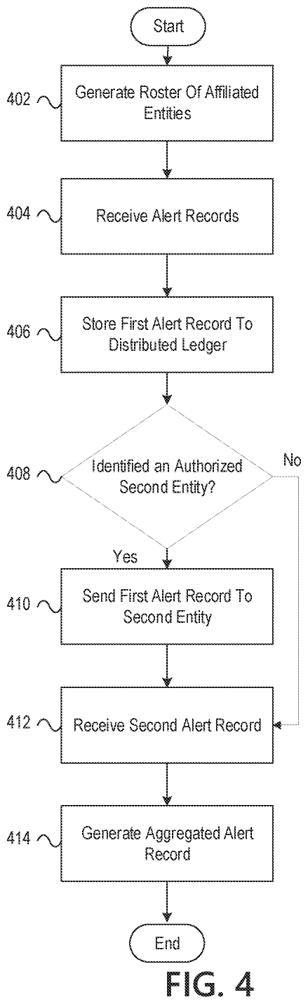

FIG. 4 depicts an illustrative method for a collaborative alert platform using distributed ledger technology in accordance with one or more example arrangements described herein. Referring to FIG. 4, at step 402, a computing device having at least one processor, a communication interface, and memory may generate a roster of affiliated entities. At step 404, the computing device may receive alert records from one or more sources. At step 406, the computing device may store a first alert record received at step 404 to a distributed ledger. At step 408, the computing device may determine whether there is an authorized second entity, authorized to access the first alert record. Based on identifying there is not an authorized second entity, the computing device may proceed to step 412. Based on identifying that there is an authorized second entity, the computing device may proceed to step 410. At step 410, the computing device may send the first alert record to the authorized second entity. At step 412, the computing device may receive a second alert record. At step 414, the computing device may generate an aggregated alert record based on the first alert record and the second alert record.

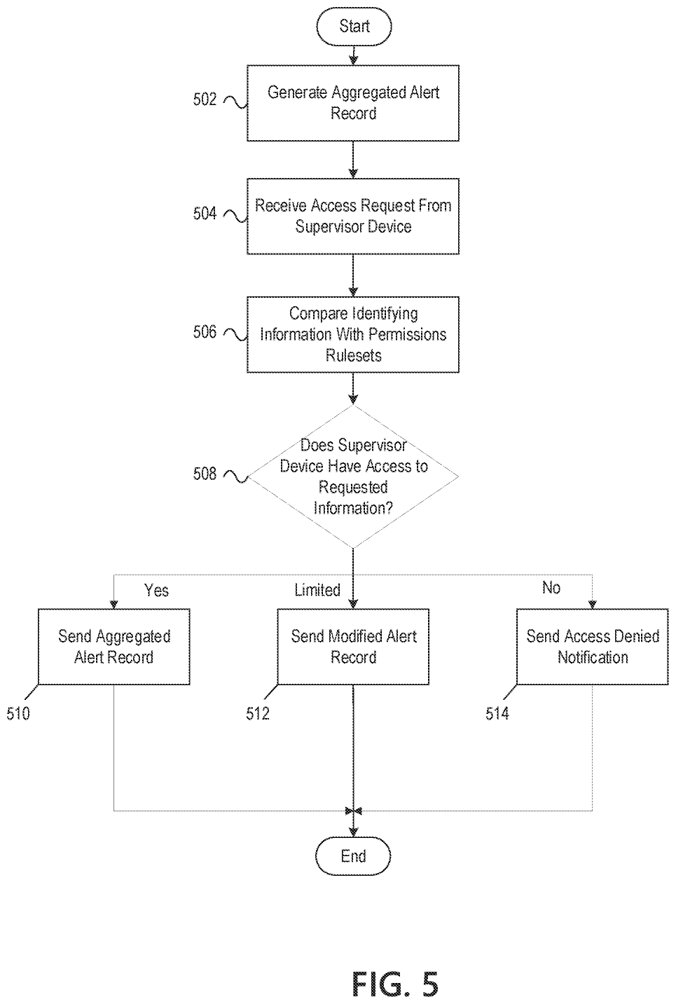

FIG. 5 depicts an illustrative method for providing alert record information to a supervisor device using a collaborative alert platform using distributed ledger technology in accordance with one or more example arrangements described herein. Referring to FIG. 5, at step 502, a computing device having at least one processor, a communication interface, and memory may generate an aggregated alert record. At step 504, the computing device may receive an access request for access to the aggregated alert record from a supervisor device. At step 506, the computing device may compare identifying information from the access request with a plurality of permissions rulesets. At step 508, based on comparing the identifying information with the plurality of permissions rulesets, the computing device may determine whether the supervisor device has access to the aggregated alert record.

Based on identifying that the supervisor device has full access to the aggregated alert record, the computing device may proceed to step 510. Based on identifying that the supervisor device has limited access to the aggregated alert record, the computing device may proceed to step 512. Based on identifying that the supervisor device does not have access to the aggregated alert record, the computing device may proceed to step 514. At step 510, the computing device may send the aggregated alert record to the supervisor device and may not perform steps 512 or 514. At step 512, the computing device may send a modified alert record to the supervisor device and may not perform step 514. At step 514, the computing device may send an access denied notification to the supervisor device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various arrangements. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative arrangements, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative arrangements thereof. Numerous other arrangements, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
generate, based on identification information received from a plurality of entities, a roster of affiliated entities, wherein each entity is affiliated with a first organizational venture;
receive, from a first user device associated with a first entity, of the roster of affiliated entities, one or more alert records, wherein a given alert record comprises:
information corresponding to an impact event detected by the first entity;
a list of entities affected by the impact event; and
a permissions ruleset, wherein the permissions ruleset comprises at least one rule for permitting access to the given alert record;
store a first alert record, of the one or more alert records, wherein storing the first alert record comprises adding an entry to a stored distributed ledger comprising at least one historical alert record;
identify, based on the first alert record, a second entity, wherein the second entity is authorized to view the first alert record;
send, based on identifying the second entity, the first alert record to a second user device associated with the second entity, wherein sending the first alert record causes the second user device to trigger a cybersecurity investigation;
receive, from the second user device, a second alert record, wherein the second alert record comprises information, detected by the second entity, corresponding to the impact event detected by the first entity;
generate, in the stored distributed ledger, an aggregated alert record corresponding to the impact event detected by the first entity, wherein the aggregated alert record comprises:
at least a portion of the first alert record; and
at least a portion of the second alert record; and
modify, based on the aggregated alert record, the stored distributed ledger, wherein modifying the stored distributed ledger configures the aggregated alert record for access by devices with access permissions for one or more portions of the aggregated alert record.

2. The computing platform of claim 1, wherein the memory stores additional instructions that, when executed by the at least one processor, further cause the computing platform to:
receive, from a supervisor device, a request to access the aggregated alert record corresponding to the impact event detected by the first entity, wherein the request comprises identifying information corresponding to the supervisor device;
compare the identifying information with a plurality of permissions rulesets corresponding to the impact event;
based on identifying that the supervisor device has full access to the aggregated alert record, send, to the supervisor device, the aggregated alert record; and
based on identifying that the supervisor device has limited access to the aggregated alert record:
generate, based on the plurality of permissions rulesets, a modified alert record, wherein the modified alert record comprises at least one of:
a portion of the first alert record, or
a portion of the second alert record; and
send the modified alert record to the supervisor device.

3. The computing platform of claim 1, wherein the first organizational venture comprises at least one of the following:
a public health venture,
a financial venture,
a political venture,
a charitable venture, or
an international venture.

4. The computing platform of claim 1, wherein the impact event detected by the first entity comprises at least one of the following:
an unauthorized transaction, a potentially unlawful action, a potential cyberattack, a security warning, a public health concern, or a public safety concern.

5. The computing platform of claim 1, wherein the list of entities affected by the impact event is determined by an automated process implemented by the first entity.

6. The computing platform of claim 1, wherein the information corresponding to the impact event comprises at least one of the following:
a source of the impact event,
an identity of an entity associated with the impact event,
global positioning information associated with the impact event, or
temporal information corresponding to the impact event.

7. The computing platform of claim 1, wherein sending the first alert record further causes the second user device to initiate, based on a result of the cybersecurity investigation, one or more security actions.

8. The computing platform of claim 1, wherein the sending the first alert record is further based on receiving a request for the first alert record from the second user device.

9. The computing platform of claim 1, wherein the instructions further cause the computing platform to:
send, based on the aggregated alert record, a modified alert record to a third user device associated with a third entity, wherein the modified alert record:
includes, based on a permissions ruleset of the second alert record, at least one portion of the second alert record; and
excludes, based on a permissions ruleset of the first alert record, the first alert record.

10. A method comprising:
at a computing platform comprising at least one processor, a communication interface, and memory:
generating, based on identification information received from a plurality of entities, a roster of affiliated entities, wherein each entity is affiliated with a first organizational venture;
receiving, from a first user device associated with a first entity, of the roster of affiliated entities, one or more alert records, wherein a given alert record comprises:
information corresponding to an impact event detected by the first entity;
a list of entities affected by the impact event; and
a permissions ruleset, wherein the permissions ruleset comprises at least one rule for permitting access to the given alert record;
storing a first alert record, of the one or more alert records, wherein storing the first alert record comprises adding an entry to a stored distributed ledger comprising at least one historical alert record;
identifying, based on the first alert record, a second entity, wherein the second entity is authorized to view the first alert record;
sending, based on identifying the second entity, the first alert record to a second user device associated with the second entity, wherein sending the first alert record causes the second user device to trigger a cybersecurity investigation;
receiving, from the second user device, a second alert record, wherein the second alert record comprises information, detected by the second entity, corresponding to the impact event detected by the first entity;
generating, in the stored distributed ledger, an aggregated alert record corresponding to the impact event detected by the first entity, wherein the aggregated alert record comprises:
at least a portion of the first alert record; and
at least a portion of the second alert record; and
modifying, based on the aggregated alert record, the stored distributed ledger, wherein modifying the stored distributed ledger configures the aggregated alert record for access by devices with access permissions for one or more portions of the aggregated alert record.

11. The method of claim 10, further comprising:
receiving, from a supervisor device, a request to access the aggregated alert record corresponding to the impact event detected by the first entity, wherein the request comprises identifying information corresponding to the supervisor device;
comparing the identifying information with a plurality of permissions rulesets corresponding to the impact event;
based on identifying that the supervisor device has full access to the aggregated alert record, sending, to the supervisor device, the aggregated alert record; and
based on identifying that the supervisor device has limited access to the aggregated alert record:
generating, based on the plurality of permissions rulesets, a modified alert record, wherein the modified alert record comprises at least one of:
a portion of the first alert record, or
a portion of the second alert record; and
sending the modified alert record to the supervisor device.

12. The method of claim 10, wherein the list of entities affected by the impact event is determined by an automated process implemented by the first entity.

13. The method of claim 10, wherein sending the first alert record further causes the second user device to initiate, based on a result of the cybersecurity investigation, one or more security actions.

14. The method of claim 10, wherein the sending the first alert record is further based on receiving a request for the first alert record from the second user device.

15. The method of claim 10, further comprising:
sending, based on the aggregated alert record, a modified alert record to a third user device associated with a third entity, wherein the modified alert record:
includes, based on a permissions ruleset of the second alert record, at least one portion of the second alert record; and
excludes, based on a permissions ruleset of the first alert record, the first alert record.

16. One or more non-transitory computer-readable media storing instructions that, when executed by a computing platform comprising at least one processor, a communication interface, and memory, cause the computing platform to:
generate, based on identification information received from a plurality of entities, a roster of affiliated entities, wherein each entity is affiliated with a first organizational venture;
receive, from a first user device associated with a first entity, of the roster of affiliated entities, one or more alert records, wherein a given alert record comprises:
information corresponding to an impact event detected by the first entity;
a list of entities affected by the impact event; and
a permissions ruleset, wherein the permissions ruleset comprises at least one rule for permitting access to the given alert record;
store a first alert record, of the one or more alert records, wherein storing the first alert record comprises adding an entry to a stored distributed ledger comprising at least one historical alert record;
identify, based on the first alert record, a second entity, wherein the second entity is authorized to view the first alert record;
send, based on identifying the second entity, the first alert record to a second user device associated with the second entity, wherein sending the first alert record causes the second user device to trigger a cybersecurity investigation;
receive, from the second user device, a second alert record, wherein the second alert record comprises information, detected by the second entity, corresponding to the impact event detected by the first entity; and
generate, in the stored distributed ledger, an aggregated alert record corresponding to the impact event detected by the first entity, wherein the aggregated alert record comprises:
at least a portion of the first alert record;
at least a portion of the second alert record; and
modify, based on the aggregated alert record, the stored distributed ledger, wherein modifying the stored distributed ledger configures the aggregated alert record for access by devices with access permissions for one or more portions of the aggregated alert record.

17. The one or more non-transitory computer-readable media of claim 16 storing instructions that further cause the computing platform to:
receive, from a supervisor device, a request to access the aggregated alert record corresponding to the impact event detected by the first entity, wherein the request comprises identifying information corresponding to the supervisor device;
compare the identifying information with a plurality of permissions rulesets corresponding to the impact event;
based on identifying that the supervisor device has full access to the aggregated alert record, send, to the supervisor device, the aggregated alert record; and
based on identifying that the supervisor device has limited access to the aggregated alert record:
generate, based on the plurality of permissions rulesets, a modified alert record, wherein the modified alert record comprises at least one of:
a portion of the first alert record, or
a portion of the second alert record; and
send the modified alert record to the supervisor device.

18. The one or more non-transitory computer-readable media of claim 16, wherein sending the first alert record further causes the second user device to initiate, based on a result of the cybersecurity investigation, one or more security actions.

19. The one or more non-transitory computer-readable media of claim 16, wherein sending the first alert record is further based on receiving a request for the first alert record from the second user device.

20. The one or more non-transitory computer-readable media of claim 16 storing instructions that further cause the computing platform to:
send, based on the aggregated alert record, a modified alert record to a third user device associated with a third entity, wherein the modified alert record:
includes, based on a permissions ruleset of the second alert record, at least one portion of the second alert record; and
excludes, based on a permissions ruleset of the first alert record, the first alert record.
